(19) United States
(12) Patent Application Publication
(10) Pub. No.: US 2002/0027968 A1
(43) Pub. Date: Mar. 7, 2002

(54) Monolithically integrated device

(76) Inventor: Ubaldo Mastromatteo, Cornaredo (IT)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/888,058

(22) Filed: Jun. 22, 2001

Related U.S. Application Data
(63) Continuation-in-part of application No. 09/077,461, filed on Feb. 8, 1999, now abandoned.

(30) Foreign Application Priority Data
Nov. 30, 1995 (IT) MI95A002502

(51) Int. Cl. G21J 1/00; G21B 1/00

(52) U.S. Cl. 376/100

(57) ABSTRACT

A monolithically integrated device. The monolithically integrated device provides advantages over conventional systems in reducing dissipation of hydrogen and its isotopes from sources of same to potentially increase absorption of hydrogen and its isotopes by absorbing materials. In some embodiments, the monolithically integrated device includes a first structure of a first material in solid form configured to absorb hydrogen. Further included is a second structure of a second material in solid form configured to release hydrogen when it reaches a temperature higher than a prefixed temperature. Both the first and second structures are superposed to a substrate and are in contact, at least partly, with one another. Additionally, a third structure of a third material in solid form is included to generate thermal energy when it is submitted to the passage of electric current and is so placed as to be thermally coupled at least to said second structure.

### CROSS-REFERENCE TO PRIOR APPLICATIONS

This application is a Continuation-In-Part of pending U.S. patent application Ser. No. 09/077,641, filed Feb. 8, 1999, which was converted into the United States from International Application No. PCT/IT/96/00226 with an international filing date of Nov. 26, 1996, which claims priority to Italian Application No. M195A002502, filed Nov. 30, 1995.

### BACKGROUND OF THE INVENTION

1. Field of the Invention

This invention relates to a monolithically integrated device including structures involving storage, release and absorption of hydrogen and its isotopes, such as deuterium and tritium.

2. Description of the Related Art

Research studies including identifying and understanding possible reactions involving hydrogen and its isotopes, such as deuterium and tritium have used several materials including some based on palladium, titanium, platinum, nickel, and niobium. These research studies typically use gaseous or liquid mixtures, such as electrolytic compounds of hydrogen in heavy water as sources for hydrogen and its isotopes, such as deuterium and tritium. Unfortunately, these conventional fluid sources for hydrogen, and its isotopes involve unwanted dissipation resulting in losses whereby the effectiveness of these sources to provide desired concentrations of hydrogen and its isotopes is compromised.

Some of these research studies also involve elevated temperatures, which further compound the dissipation problems of these conventional fluid sources for hydrogen and its isotopes. At elevated temperatures, the liquid sources tend to boil and the gaseous sources tend to experience reductions in concentrations.

### SUMMARY OF THE INVENTION

The present invention resides in a monolithically integrated device. Aspects of the system and method involve a substrate and, at least in a portion a first structure of a first material in solid form configured to absorb hydrogen. Superposed to the substrate is a second structure of a second material in solid form configured for release of hydrogen when the second structure reaches a temperature higher than a prefixed temperature. Superposed to the substrate are the first and second structures, which are in contact at least partly with one another.

Further aspects include the first and second structures being at least partly superposed to one another. Other aspects include an insulating structure of thermally insulating material interposed between the first and second structures and the substrate. Additional aspects include a third structure of a third material in solid form configured to generate thermal energy when it is submitted to the passage of electric current, so placed as to be thermally coupleable at least to the second structure.

Other features and advantages of the invention will become apparent from the following detailed description, taken in conjunction with the accompanying drawings.

### BRIEF DESCRIPTION OF THE DRAWINGS

FIG. 1 shows the section of a first device according to this invention.

FIG. 2 shows the top view of the device of FIG. 1.

FIG. 3 shows the section of part of a second device according to this invention.

FIG. 4 shows the top view of the device of FIG. 3.

FIG. 5 shows the section of part of a third device according to this invention.

FIG. 6 shows the bottom view of the device of FIG. 5.

FIG. 7 shows the section of a greater part of the device of FIG. 1.

FIG. 8 shows the section of a greater part of the device of FIG. 3.

FIG. 9 shows the section of a greater part of the device of FIG. 5.

FIG. 10 shows schematically the top view of the whole part of generation of thermal and electric energy of the device of FIG. 8.

FIG. 11 shows schematically the top view of the whole device of FIG. 8.

FIG. 12 shows schematically the top view of a thermopile of a known type utilizable in the device of FIG. 10.

### DETAILED DESCRIPTION OF THE INVENTION

Embodiments of a monolithically integrated device is described. By utilizing a structure of a solid form material configured to release hydrogen and its isotopes when it reaches a temperature higher than a prefixed temperature, and putting it in contact with another structure from another solid form material configured to absorb hydrogen and its isotopes, and if the “releasing” material is, at least for a short time, at least in one part, at a temperature exceeding said prefixed temperature, the absorbing solid material has greater opportunity to absorb or otherwise react with the hydrogen and its isotopes than with conventional approaches. The invention will be more clearly stressed by the following description, considered together with the attached drawings.

The invention starts from the recognition that in the field of integrated electronic circuits it is known that, during the fabrication of the same, some component materials, such as for instance boron nitride, silicon carbide, silicon nitride, aluminium arsenide, gallium arsenide enrich in hydrogen, causing degradations of the performances; such phenomenon is explained, for instance, in S. Manzini's article, “Active doping instability in n+-p silicon surface avalanche diodes”, Solid form Electronics, Vol. 32, Nr. 2, pp. 331-337, 1995. In conventional practices this hydrogen enrichment is viewed as unwanted, however, the present invention takes advantage of such phenomena to usefully exploit this “noxious” property of such materials.

A process step, typical of the techniques of fabrication of electronic integrated circuits, which leads to the formation of hydrogen-rich materials is the PECVD (Plasma Enhanced Chemical Vapor Deposition); details on this process step and also on all the fabrication techniques of silicon-based integrated electronic circuits may be drawn from S. M. Sze's book, “VLSI Technology”, McGraw-Hill, 1988; in addition, fabrication techniques that are specific of the integrated electronic circuits based on germanium and gallium arsenide are well known in the literature.

A typical chemical reaction between hydrogen compounds using the PECVD technique is the following one:

$${AH}_{n} + {BH}_{m} ⇒ {A}_{x} {B}_{y} + A - {H}_{j} + B - {H}_{k} + {H}_{2} \qquad [ 1 ]$$

Such oxidoreduction reaction [1] takes place from leftside to rightside if we reach a rather high temperature T1, for instance 400° C., and if we cause the two leftside reagents to be in the plasma phase instead that in the gaseous phase. At such “low” temperature T1, the reaction [1] is not complete and stoichiometric and many bonds remain therefore between hydrogen and the A and B elements; generally, these bonds are single, i.e., “j” and “k” are equal to one; from reaction [1] a solid composition is obtained that has a high content of chemically bound hydrogen (and therefore of deuterium and tritium) and of gaseous state hydrogen, which does not remain in high amount in the composition.

If the so obtained solid composition is heated afterwards (even after a possible cooling at room temperature) up to a temperature T2 higher than the previous one, for instance 800° C., reaction [1] becomes complete and stoichiometric, i.e., the following reaction takes place:

$$A - {H}_{j} + B - {H}_{k} ⇒ {A}_{x} {B}_{y} + {H}_{2} \qquad [ 2 ]$$

with release of the hydrogen contained.

At temperatures comprised between T1 and T2 only the more weakly bound atoms will be released.

Of course, temperatures T1 and T2 depend on the A and B elements utilized; besides, it must be taken into account that there are no critical values which cause abrupt variations in the reaction speed for reactions [1] and [2].

Therefore, the method according to this invention proposes to utilize a first structure from a first material in solid form configured to absorb hydrogen, and to utilize a second structure from a second material in solid form configured to release hydrogen when it is at a temperature higher than a prefixed temperature, to put in contact at least partly to one another said first and said second structure, and to heat at the start at least said second structure, at least until it has exceeded said prefixed temperature in at least one part; the starting heating may also be caused by the environment where the two structures are placed.

The starting heating causes in the second structure the release of some hydrogen. Such hydrogen will move, for instance by diffusion in the solid state, in the second structure and pass, at least partly into the first structure, as this one is in contact with the second structure. The first structure then absorbs hydrogen with possible other results as well. If other heat sources are not provided, the “starting” heating can be expected to go on, for instance, for the whole duration of absorption by the first structure. The aforementioned silicon nitride-based solid composition is only one of the possible second materials that stresses such release properties; of course, such second materials may be produced according to different techniques, among which the PECVD.

For the first material, one can choose among: palladium, titanium, platinum, nickel, and alloy thereof, and any other material showing such absorption property. The fact that the starting heating of the second structure may involve, in some cases, a starting heating also of the first structure through their contact, is an advantage as, in such cases, the hydrogen absorption by the first structure is spurred; such heating may also be spurred, if necessary, by a suitable arrangement of the materials and the thermal energy source.

Relying on the spontaneous movement of hydrogen in the second structure towards the first structure may lead to an insufficient absorption by the first structure. To obviate this drawback, it is convenient that at least part of the second structure be submitted to an electric field with field lines having such shape and direction as to spur the movement of the nuclei of such hydrogen released in the second structure towards the first structure.

The intensity of the electric field can be fixed beforehand on the basis of the rate and amount of absorption by the first structure desired. One could also obtain different absorption rates and levels by the first structure at different times by varying the intensity of the electric field during course of operations. Through field inversion it is even possible to cancel the effect of the spontaneous movement of hydrogen, and therefore to inhibit entirely the absorption of hydrogen by the first structure.

With reference to the case in which the second material is a silicon nitride-based solid composition, the hydrogen and its isotopes that are released through reaction [2] are absorbed by the first absorbing material with good efficiency, as the two materials are in contact with one another and both of them are solid. The concentration of hydrogen in the second material, in terms of atoms per cubic centimeter, is determined to be sufficient to originate an appreciable rate or level of absorption of hydrogen in the first material.

In the case of silicon nitride used for the second structure and nickel used for the first structure, a concentration of 10²² may be chosen for the hydrogen in the silicon nitride and the nitride mass may be caused to be 9 times greater than the nickel mass; in this way, the number of hydrogen atoms that can be released is about equal to the number of nickel atoms available; in fact, the density of nickel is equal to 9×10²².

Actually, in some applications, the presence of the AₓB_{y} compound in the solid composition is not strictly indispensable; what matters is the presence of A-Hⱼ+B-Hₖ: therefore, it would be theoretically possible to utilize only either A-Hⱼ or B-Hₖ.

Of course, one cannot exclude the presence in the solid composition of other chemical elements or compounds which might not take part, absolutely or to a relevant extent, in the chemical reaction between the A, B, H elements.

In some applications it is relatively important to cause reaction [1] not to complete in reaction [2], so as to trap much hydrogen in the resulting solid composition. If some chemically unbound hydrogen be trapped in the composition but, for instance, in atomic and/or molecular and/or ionic form, this would be no problem, but on the contrary an advantage, as surely it would be released once the composition has been heated up to a temperature higher than T1.

With silicon nitride and utilizing the aforementioned PECVD techniques, hydrogen concentrations equal to 10²² atoms per cubic centimeter are easily reached.

The above set forth method can be realized by means of a monolithically integrated device comprising a substrate and, at least in one part:

a) a first structure of a first material in solid form configured to absorb hydrogen, superposed to said substrate, and

b) a second structure of a second material in solid form configured to release hydrogen when it reaches a temperature higher than a prefixed temperature, superposed to said substrate,

and wherein the first and the second structure are in contact at least partly with one another.

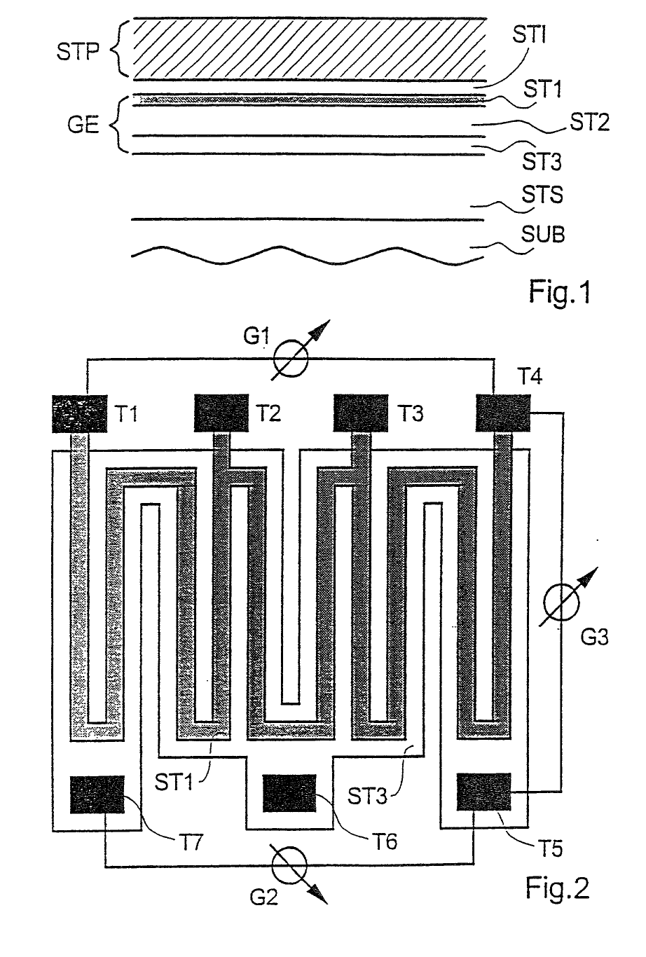

In FIGS. 1, 2, 3, 4, 5, 6, the first structure is indicated by ST1 and the second structure by ST2, while the substrate is indicated by SUB; its function is to support the device and it may be realized, for instance, from silicon.

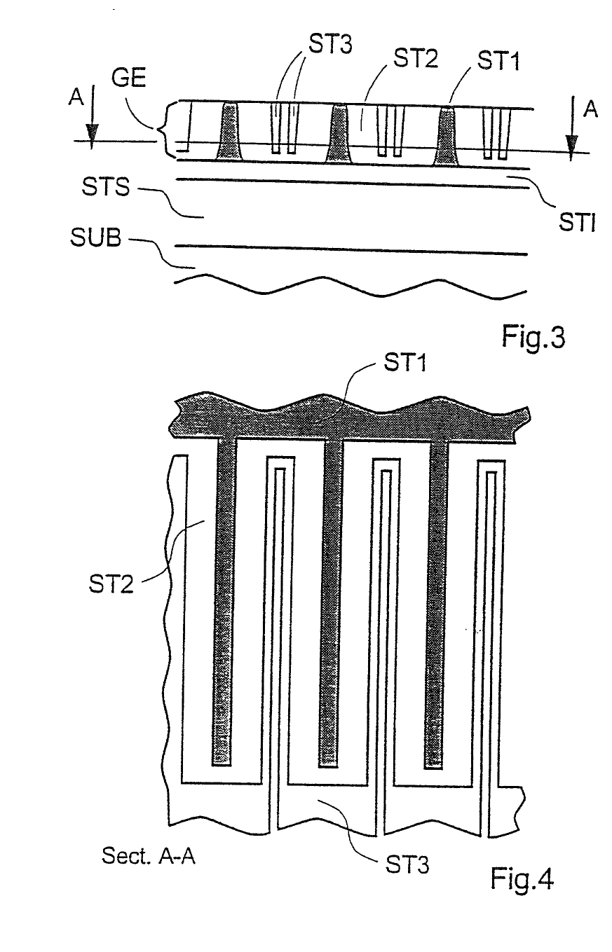

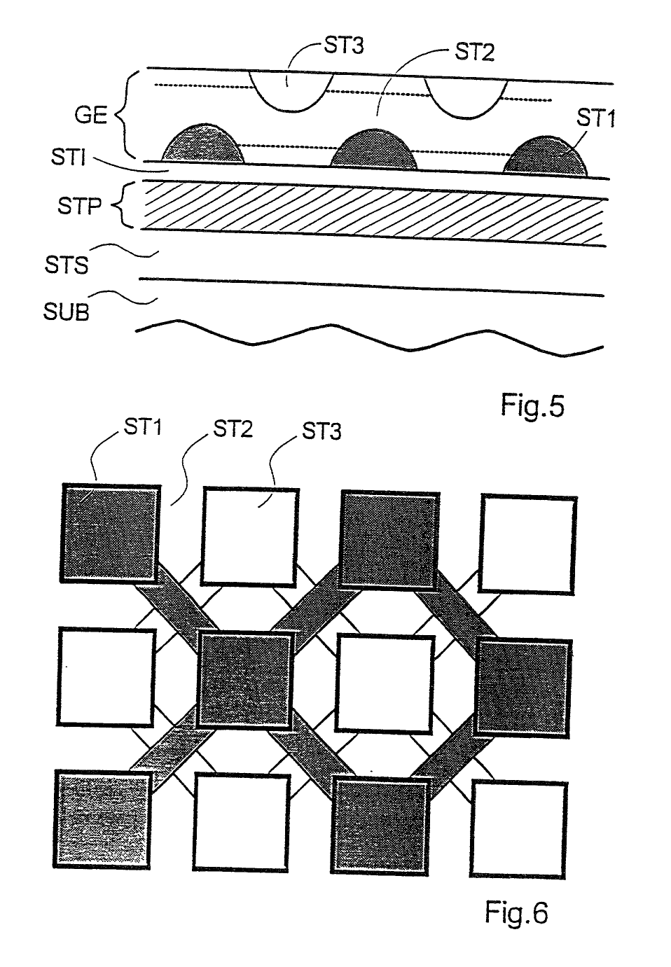

There exist several methods to put structure ST1 in contact with structure ST2; in the embodiment of FIG. 1, they are superposed, and therefore the hydrogen released in structure ST2 follows a substantially vertical path to pass to structure ST1; in the embodiment of FIG. 3, they are placed side by side, and therefore the hydrogen follows a substantially horizontal path; in the embodiment of FIG. 5, structure ST2 surrounds structure ST1, and therefore the hydrogen follows a path which depends on its starting position and which may be either horizontal or vertical or oblique.

The whole of structure ST1, structure ST2 and, possibly a third structure ST3, of which we shall speak later on, forms an exchanger GE.

Between the exchanger GE and substrate SUB an insulating structure STS or thermally insulating material is advantageously placed, for instance a thick layer of silicon dioxide, so as to prevent thermal energy from dissipating from exchanger GE through conduction in substrate SUB or damaging it; in the embodiments of FIGS. 1, 3, 5, the material of structure STS is usefully also an electric insulator, to prevent current dissipations; this is true for silicon dioxide.

To obtain the already mentioned starting heating, the device should usefully furtherly comprise, at least in the part occupied by the exchanger GE, a third structure ST3 of a third material in solid form configured to generate thermal energy when it is submitted to the passage of electric current, so placed as to be thermally coupled at least to said second structure ST2; said third material may be, for instance, polysilicon or doped polysilicon; structure ST3 is a resistor realizable therefore in any of the numerous ways well known in the sector of integrated circuits.

In the embodiment of FIGS. 1, 2 structure ST1 and structure ST3 are shaped as a line, preferably bent, and are practically fully superposed; the width of line of structure ST3 is much greater than the width of line of the first structure ST1, so that it is possible to obtain a good heating; structure ST2 occupies the resting part of the space and is shaped as a substantially rectangular and flat plate.

In the embodiment of FIGS. 3, 4, structures ST1, ST2, ST3 are substantially all shaped as a bent line and are placed side by side; a variant consists in the realization of structure ST1 in the shape of a “comb” whose teeth insert in the loops of the bent line, as shown in the figures; another variant consists in giving structures ST1 and ST2 the same shape.

In the embodiment of FIGS. 5, 6, structures ST1 and ST3 have substantially the same shape and are formed by a plurality of cells, for instance and as shown in the figures, having a square form, connected to one another, for instance, by narrower and thinner channels; structure ST2 occupies the resting part of the space.

Alternatively or in addition to the heating function, structure ST3 may have, in combination with structure ST1, the function of polarization of the material of structure ST2; by applying to these suitable potentials an electric field may generate with field lines having such shape and direction as to spur the movement of the nuclei of such hydrogen released in structure ST2 towards structure ST1.

In the embodiment of FIGS. 5, 6, a part of structure ST3, in particular the cells, is prevailingly used for the polarization function, and another part of the same, in particular the channels, is prevailingly used for the heating function. In the embodiments of FIGS. 1, 2 and FIGS. 3, 4, structure ST3 performs both of the functions.

With reference to the embodiment of FIGS. 1, 2, structure ST1 is provided with at least two terminals T1, T4, and structure ST3 is provided with at least two terminals T5, T7; besides, there is a first voltage generator G1 coupled to the two terminals T1, T4 of structure ST1, a second voltage generator G2 coupled to the two terminals T5, T7 of structure ST3, and a third voltage generator G3 coupled to terminal T4 and terminal T5; one notices that structure ST1 and structure ST3 form approximately a condenser with two flat parallel plates in which a dielectric is interposed constituted by structure ST2.

Generator G2 performs the heating function, while generator G3 performs the polarization function; generator G1 may be advantageously utilized, in case of necessity, to optimize the polarization function; in fact, as the potential of structure ST3 changes from point to point because of generator G2 and as, in general, the materials of structure ST1 and of structure ST3 are different, it may be important to check, through generator G3, the intensity of the electric field and therefore the polarization of structure ST2 when the position changes, for instance to obtain a uniform generation of thermal energy.

FIG. 2 shows also terminals T2 and T3, additional for structure ST1, and terminal T6 additional for structure ST3; such additional terminals in combination with the “normal” terminals, may be advantageously utilized both to better control the polarization of structure ST2, and to better control the heating of structure ST1, as well as to better control absorption of hydrogen, for instance by excluding completely only part of structure ST3 from the generation of thermal energy.

Of course, to exploit all the opportunities offered by the device of FIGS. 1, 2, it is necessary to provide all the control circuits for the generators connected to the above terminals.

Also in the embodiments of FIGS. 3, 4 and FIGS. 5, 6, structures ST1 and ST3 may be provided with like terminals, even though they are not shown in said figures.

A typical application of the exchanger GE is in testing materials used for absorbing hydrogen and its isotopes, however, other applications beyond testing could exist such as implementing results discovered regarding such absorbing materials.

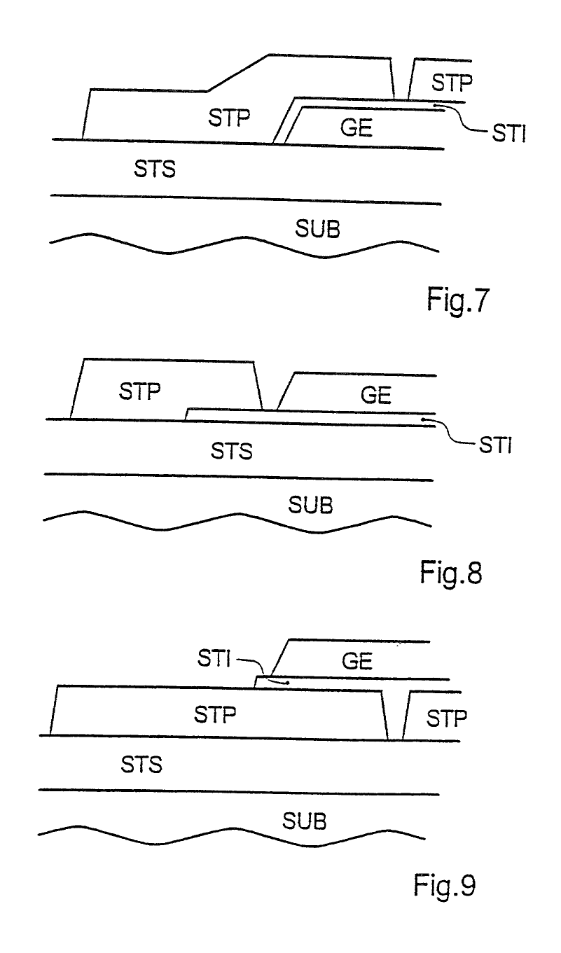

In FIGS. 1 and 7, exchanger GE is placed on structure STS and covered by a structure ST1 from electrically insulating and thermally conductive material, for instance, diamond; the thermopile converter test probe STP is placed with its hot contact part on structure ST1, which ensures a good thermal coupling, and the resting part on structure STS.

In FIGS. 3, 8, the exchanger GE is placed on structure ST1, which in its turn is placed on structure STS; structure ST1 extends much beyond the edge of the exchanger GE; the thermopile converter test probe STP is place sideways on the exchanger GE, and more particularly with its hot contact part on structure ST1, which ensures a good heat transfer, and the resting part on structure STS.

In FIGS. 5, 9, the exchanger GE is placed on structure ST1, which ensures a good thermal coupling, which, in its turn, is placed on the hot contact part of the thermopile converter test probe STP; converter STP is placed on structure STS.

FIG. 12 shows schematically the top view of a thermopile test probe TP; this comprises a fourth flat structure ST4 made from a fourth electric conductive material shaped as an “L”, a sixth flat structure ST6 from a sixth electric conductive material, other than the fourth one, shaped as an “L”, and a fifth flat structure ST5 from electrically conductive material; structure ST5 has a shape complementary to structure ST6 and flanks the latter on both sides of the “L”; structure ST4 is superposed to the two other structures, so as to have a region of electric contact with structure ST6 at a first extremity, called region of hot contact; at the second extremity, structures ST4 and ST6 present respectively a first terminal P1 and a second terminal P2. If the first extremity of structures ST4 and ST6 is brought to a temperature higher than the temperature of their second extremity, a difference of potential creates between terminals P1 and P2, generally of the order of hundreds millivolts, which depends on the difference of temperature; hence the necessity of the serial connection. The materials utilizable for elements E1 and E2 are well known in the literature.

It is obvious from what has been set forth that the thermopile test probes operate also as temperature sensors of the exchanger GE for feedback as to conditions regarding absorption of hydrogen and its isotopes by the first structure.

If the exchanger GE and the thermopile converter test probe STP are placed sideways on one another as shown in FIG. 8, it is advantageous to choose the material of structure ST4 equal to the material of structure ST1, the material of structure ST5 equal to the material of structure ST2, the material of structure ST6 equal to the material of structure ST3, so that both the thermopile test probes TP and the exchanger GE can be realized through the same process steps.

The same aim may be reached by choosing the material of structure ST4 equal to the material of structure ST3, the material of structure ST5 equal to the material of structure ST2, the material of structure ST6 equal to the material of structure ST1.

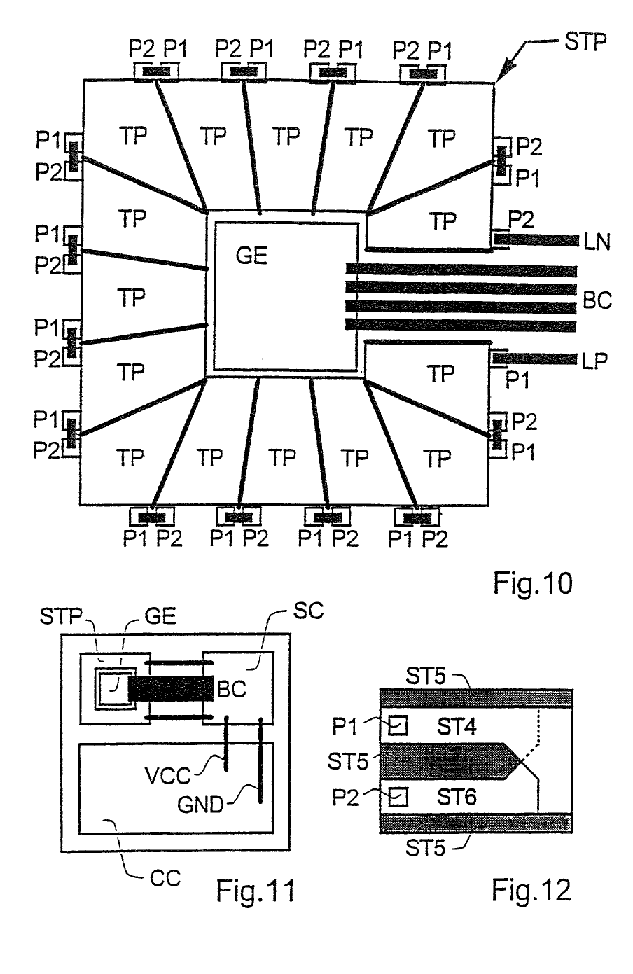

FIG. 10 shows a structure which might constitute a complete device encloseable in a package and configured to couple to an electric or electronic circuit.

This comprises a exchanger GE, for instance that shown in FIGS. 3, 4, 8, connected to, for instance, four electric lines, to feed the terminals of structures ST1 and ST3, which, as a whole, form a bus BC for the control of the absorption of hydrogen and its isotopes, and comprises a thermopile converter test probe STP formed by fifteen thermopiles test probes TP crown-arranged around the exchanger GE, electrically insulated from one another and electrically insulated from the exchanger GE, but thermally coupled to the same; the crown is open to allow the passage of bus BC.

The thermopile test probes TP are serially connected with one another, i.e., terminal P2 of one of them is connected to terminal P1 of the adjoining one; terminal P1 of the first one is connected to a positive line LP; terminal P2 of the last one is connected to a negative line LN. Lines LP and LN may therefore be utilized are terminals of a voltage generator.

The structure of FIG. 10 may alternatively be utilized inside a conventional integrated system as feeding source.

FIG. 11 shows the structure of one such integrated circuit, which structure comprises: the exchanger GE, a control bus BC connected to the exchanger GE, the thermopile converter test probe STP, two lines LP and LN—positive and negative—connected to the thermopile converter test probe STP, control circuit SC monolithically integrated, connected to bus BC and lines LP and LN, two feeding and mass lines VCC and GND connected to circuit SC, an applicative circuit CC monolithically integrated, configured to perform analogic and/or logic electric functions of a conventional type and connected to lines VCC and GND to be fed by them.

Circuit SC, which in a simple embodiment might also be omitted, can perform the following functions: take the current required by circuit CC, send to the terminals of the structures of the exchanger GE suitable voltages through bus BC, take the temperature of the exchanger GE through lines LP and LN, receive the voltage generated by the thermopile converter test probe STP through lines LP and LN, stabilize the voltage supplied to lines VCC and GND.

1. A monolithically integrated device comprising a substrate and, at least in a portion:
a) a first structure of a first material in solid form configured to absorb hydrogen, superposed to said substrate; and
b) a second structure of a second material in solid form configured to release hydrogen when it reaches a temperature higher than a prefixed temperature, superposed to said substrate, said first and said second structure being in contact at least partly with one another.

2. The device according to claim 1 wherein said first and said second structure are superposed to one another at least partly.

3. The device according to claims 1, further comprising, at least in said portion, an insulating structure of thermally insulating material interposed between said first and said second structures and said substrate.

4. The device according to claim 1, further comprising, at least in said portion, a third structure of a third material in solid form, configured to generate thermal energy when it is submitted to the passage of electric current, so placed as to be thermally coupleable at least to said second structure.

5. The device according to claim 4 wherein said first and said third structures are shaped as a line, preferably bent, and are practically fully superposed and wherein the width of line of said third structure is much greater than the width of line of said first structure.

6. The device according to claim 4 wherein said first structure is provided with at least two terminals, said structure is provided with at least two terminals, and further comprises a first voltage generator coupled with the two terminals of said first structure, a second voltage generator coupled with the two terminals of said third structure, and a third voltage generator coupled with a terminal of said first structure and with a terminal of said third structure, and a control circuit for said voltage generators.

7. The device according to claim 6 wherein said first structure is provided with a plurality of terminals.

8. The device according to claim 1, further comprising a converter for measuring absorption of hydrogen of the first structure.

9. The device according to claim 8 wherein said converter comprises a thermopile system so placed that its hot contact regions are thermally coupled to at least said first structure.

10. The device according to claim 9 wherein said thermopile system comprises:
a) a fourth structure of a fourth material as a first thermopile terminal,
b) a fifth structure of an electrically insulating material, and
c) a sixth structure of a sixth material other than said fourth material as a second thermopile terminal,
and is placed at least partly under said first and second structures.

11. The device according to claim 9 wherein said thermopile system comprises:
a) a fourth structure of a fourth material equal to said first or said third material,
b) a fifth structure of an electrically insulating material equal to said second material, and
c) a sixth structure of a sixth material other than said fourth material and equal to said third or said first material,
and is placed at least sideways on said first and said second structures.

12. The device according to claims 8, further comprising a circuitry monolithically integrated on said substrate.
